(19) United States
(12) Patent Application Publication
(10) Pub. No.: US 2024/0340088 A1
(43) Pub. Date: Oct. 10, 2024

(54) Combining Unit, a Transmitter, a Quantum Communication System and Methods for Combining, Transmitting and Quantum Communication

(71) Applicant: Kabushiki Kaisha Toshiba, Tokyo (JP)

(72) Inventors: Thomas ROGER, Cambridge (GB); Chithrabhanu PERUMANGATT, Cambridge (GB); Mirko SANZARO, Cambridge (GB); Davide MARANGON, Cambridge (GB); Ravinder SINGH, Cambridge (GB); Andrew James SHIELDS, Cambridge (GB)

(73) Assignee: Kabushiki Kaisha Toshiba, Tokyo (JP)

(21) Appl. No.: 18/176,044

(22) Filed: Feb. 28, 2023

(30) Foreign Application Priority Data
Jul. 20, 2022 (GB) 2210632.2

(51) Int. Cl. H04B 10/532; G02B 6/27; H04B 10/11; H04B 10/70

(52) U.S. Cl. CPC H04B 10/532; G02B 6/2706; G02B 6/2773; H04B 10/11; H04B 10/70

(57) ABSTRACT

A combining unit for combining a first optical input and a second optical input, the first optical input comprising a first polarisation maintaining fibre “PMF” having a fast optical axis and a slow optical axis, the second optical input comprising a second PMF having a fast optical axis and a slow optical axis, the combining unit being configured to combine the first optical input with the second optical input in free space such that the fast and slow optical axis of the first PMF and the second PMF are rotated with respect to one another by a non-zero angle to produce a combined signal.

### CROSS REFERENCE TO RELATED APPLICATION

This application claims the benefit of United Kingdom Application number 2210632.2 filed on 20 Jul. 2022, which is hereby incorporated by reference.

### FIELD

Embodiments described herein relate to a combining unit, a transmitter, a quantum communication system and methods for combining, transmitting and quantum communication

### BACKGROUND

In a quantum communication system, information is sent between a transmitter and a receiver by encoded single quanta, such as single photons. Each photon carries one bit of information which can be encoded upon a property of the photon, such as its polarization.

Quantum key distribution (QKD) is a technique which results in the sharing of cryptographic keys between two parties: a transmitter often referred to as “Alice”; and a receiver often referred to as “Bob”. The attraction of this technique is that it provides a test of whether any part of the key can be known to an unauthorised eavesdropper, often referred to as “Eve”. In many forms of quantum key distribution, Alice and Bob use two or more non-orthogonal bases in which to encode the bit values. The laws of quantum mechanics dictate that measurement of the photons by Eve without prior knowledge of the encoding basis of each causes an unavoidable change to the state of some of the photons. These changes to the states of the photons will cause errors in the bit values sent between Alice and Bob. By comparing a part of their common bit string, Alice and Bob can thus determine if Eve has gained information.

### BRIEF DESCRIPTION OF THE FIGURES

FIG. 1 is a schematic of a transmitter in accordance with an embodiment;

FIG. 2 is a schematic cross section of a polarisation maintaining fibre;

FIG. 3 is a schematic of a combining unit;

FIG. 4 is a flow chart showing a method in accordance with an embodiment;

FIG. 5 is a schematic of a quantum communication system in accordance with an embodiment;

FIG. 6 is a schematic of a receiver which can be used in the system of FIG. 5; and

FIG. 7 is a schematic of a transmitter in accordance with an embodiment which can produce decoy states.

### DETAILED DESCRIPTION

In a first aspect, a combining unit for combining a first optical input and a second optical input, the first optical input comprising a first polarisation maintaining fibre “PMF” having a fast optical axis and a slow optical axis, the second optical input comprising a second PMF having a fast optical axis and a slow optical axis, the combining unit being configured to combine the first optical input with the second optical input in free space such that the fast and slow optical axis of the first PMF and the second PMF are rotated with respect to one another by a non-zero angle to produce a combined signal.

The electric field of light can be described as two perpendicular oscillating waves, which can have different amplitudes and a phase delay between them. These waves propagate together, defining the overall direction of the electric field-known as the state of polarisation of light.

Information can be encoded by modulating the optical polarisation state and in practical applications the states may be chosen from the following mutually unbiased bases which comprise two orthogonal basis states. These may be the rectilinear linear polarisation states, horizontal H and vertical V, which are oriented at angle 0 degrees and 90 degrees respectively and the mutually unbiased basis which contain the diagonal linear polarisation states, diagonal D and anti-diagonal A, oriented at 45 degrees and −45 degrees respectively. It is also possible to encode in the circular polarisation states; left-hand L and right-hand R, which comprise equal amplitudes of H and V polarised light with a relative phase delay between them of π/2 and −π/2 respectively.

The combining unit combines the output from the first and second PMFs in free space and can output directly to free space. Although the combination of the first and second PMFs could be output to a single mode fibre. Outputting directly to free space after free space combination avoids any compensation for phase drift caused by a single mode output fibre. This makes the combination unit particularly of use in free space communication situations such as satellite communications.

In an embodiment, the optical axis of the first PMF and the second PMF are mechanically rotated at a fixed angle. In a further embodiment, a quarter wave-plate is provided to convert the output from one of the PMFs to be circularly polarised.

In an embodiment, the combining unit further comprises a plurality of hierarchical combining stages, each being configured to combine two inputs into a single output, the single output being directed to the following combining stage via a PMF. The hierarchical combining stages may each comprise the above combining unit or different types of units for combining PMFs.

The combining unit recited above allows the manipulation and combination of polarisation states into a single output using polarisation maintaining fibres.

The combining unit may further comprise a correction stage configured to correct for phase drift between the outputs of the first and second PMFs. As the output from the first PMF is rotated with respect to the output of the second PMF, any phase delay between the polarisation states from the first PMF and the second PMF might result in some ellipticity occurring in some of the output states. The correction stage may be provided directly after the combination or may be provided at a receiver or the like to correct for ellipticity after the combined output has been sent across free space.

In a second embodiment, a transmitter is provided for emitting light with a polarisation selected from a set of fixed polarisations, the emitter comprising:
a main combining stage comprising a combining unit according to the above combining unit; and
a plurality of emitting units, the output of each emitting unit being directed into a polarisation maintaining fibre such that the output of at least one emitting unit is directed to the first polarisation maintaining fibre and the output of at least one other emitting unit is directed to the second polarisation maintaining fibre.

This implementation is intrinsically stable due to the use of only polarization maintaining fibre (PM) in the combining optics. PM fibre maintains the polarization state of light which travels along either the slow or fast axis of the fibre even when the fibre is stressed mechanically or thermally. Also, once the light has been multiplexed the module couples to free-space such that perturbations of the polarization state are suppressed. This is especially useful in hostile environments where the temperature may have large and fast transients. This transmitter provides a low-cost, low-power and high-speed platform to produce polarization encoded pulses.

The transmitter may further comprise a plurality of hierarchical combining stages, each being configured to combine at least two inputs into a single output, the single output being directed to the following combining stage via a PMF. In some embodiments the combining stages combine two inputs from PMFs into a single output PMF.

The transmitter may be configured to selectively output from the main combining stage at least one polarisation state in one of two non-orthogonal basis. Such a transmitter can be used for polarisation encoding in quantum key distribution (QKD). In polarisation encoding for QKD, polarisation states may be encoded to occupy a state in one of at least two non-orthogonal basis. For example, one basis may be defined by horizontal and vertically polarised states and a second basis may be defined by diagonal and anti-diagonal states. Thus, in an embodiment, the main combining unit can be considered to be a basis combining stage.

An earlier combining stage can be used to combine the states that define each basis and then PMFs containing the output, where each PMF contains the states which define each basis, are combined by the basis combining stage. The basis combining stage mechanically rotates the axis of one PMF with respect to the other. Thus, in a further embodiment, the transmitter further comprises at least one further combining stage as a state combining stage, the state combining stage being configured to combine orthogonal polarisation states which form a basis into a single output, the main combining stage being configured as a basis combining stage to combine the outputs of the state combining stage.

The state combining stage may be configured to combine polarisation states propagating in the same axis of two input PMFs and wherein the state propagating in one input PMF is coupled into the slow axis of a PMF carrying the output of the state combining stage and the state propagating in the other input PMF is coupled to the fast axis of the PMF carrying the output of the state combining stage.

The state combining stage may comprises a 2×1 beam combiner. For example, the 2×1 combiner is a fibre combiner which evanescently couples the two input PMFs.

The transmitter may comprise two state combining stages one configured to output to the first PMF and the other configured to output to the second PMF, the axis of the second PMF being rotated by 45 degrees with respect to the axis of the first PMF by the basis combining stage.

The above emitter can also be used in QKD protocols which use pulses of different intensities. This can be achieve by supplying either the basis combining stage or the state combining stage with an input that has pulses of different intensities.

Therefore, the transmitter may further comprise at least one further combining stage as an intensity combing stage, the intensity combining stage being configured to combine polarisation states with the same polarisation but different intensities into a single output.

The intensity combining stage may be configured to combine polarisation states propagating in the same axis of N input PMFs, where N is a integer of at least 2 and wherein the states propagating in each input PMF are each coupled into the same axis of a PMF carrying the output of the intensity combining stage. The intensity combining stage may comprise an Nx1 fibre combiner.

The transmitter may comprise at least three emitters, wherein the output from two of the emitters is combined at a first combining stage prior to being directed into the first polarisation maintaining fibre, the output from each emitter reaching the first combining stage via a separate polarisation maintaining optical fibre.

The transmitter may comprise a plurality of hierarchical combining stages, each being configured to combine two inputs into a single output, the single output being directed to the following combining stage via a polarisation maintaining fibre.

The plurality of emitters comprises a first emitter, a second emitter, a third emitter and a fourth emitter, wherein:
the output of the first emitter and the second emitter being combined at the first combining stage;
the output of the third emitter and the fourth emitter being combined at a second combining stage;
the output of the first combining stage being transmitted via the first polarisation maintaining fibre to the directed via a polarisation maintaining fibre to the main combining stage; and the output of the second combining stage being transmitted via the second polarisation maintaining fibre to the directed via a polarisation maintaining fibre to the main combining stage.

The transmitter may further comprise driving electronics connected to each of the plurality of emitters to allow each of the plurality of emitters to be selectively excited such that a polarisation state output from the main combining stage can be selected by exciting the corresponding emitter. The transmitter may also output vacuum states at selected time by not selecting any emitter to output at the selected time.

In a further embodiment, a quantum communication system is provided comprising the above transmitter and a receiver, said receiver being configured to receive polarisation states from said transmitter and measure said polarisation states in a first or a second polarisation basis. The receiver may be configured to passively select the polarisation basis. The receiver may comprise a polarising beam splitter and a detector configured to measure the output of said polarising beam splitter for each polarisation basis.

In a further embodiment, a method for combining a first optical input and a second optical input is provided, the first optical input being provided via a first polarisation maintaining fibre “PMF” having a fast optical axis and a slow optical axis, the second optical input being provided via a second PMF having a fast optical axis and a slow optical axis, wherein the first optical input with the second optical input in free space such that the fast and slow optical axis of the first PMF and the second PMF are rotated with respect to one another by a non-zero angle to produce a combined signal.

The method may further comprise combining the outputs of the first and second PMFs in free space by directing both outputs to impinge on a beam splitter. The method may further comprise correcting for phase differences induced by the beam splitter in the free space combination unit.

In a yet further embodiment, a method of transmitting an optical signal with a polarisation selected from a set of fixed polarisations is provided, the method comprising:

emitting polarisation states from a plurality of emitting units, the output of each emitting unit being directed into a PMF such that the output of at least one emitting unit is directed to a first PMF and the output of at least one other emitting unit is directed to the a second PMF; and combing the output of the first PMF with the output of the second PMF to produce a combined signal, wherein the optical axis of the second PMF is mechanically rotated with respect to the optical axis of the first PMF.

In a yet further embodiment, a quantum communication method is provided, the method comprising:
emitting an optical signal with polarisation states selected from a set of four polarisations according to the above method, wherein the polarisation states are randomly selected from states in two polarisation basis; and receiving at a receiver the optical signal with varying polarisation states and varying the polarisation measurement basis in the receiver.

In an embodiment, a method is provided to multiplex pulses of light from multiple light sources to encode those pulses in polarization and couple the encoded pulses to free space such that the polarization state is preserved. The system uses only polarization maintaining fibre within the multiplexing phase.

Further, a method is provided to multiplex pulses of light from multiple light sources and encode these pulses in polarization. Each light source is coupled to polarization-maintaining fibre along the fibre's slow-axis. Manipulation of the pulses of light from each of the lasers is performed by passive polarization maintaining (PM) fibre-coupled optical components.

Mechanical rotation of a polarization-maintaining fibre is exploited to modify the polarization state into the mutually unbiased basis used for polarization encoding protocols in quantum key distribution (QKD).

In an embodiment, a customized fibre-coupled 50:50 beam splitter is provided, where one of the inputs is rotated by 45 degrees to modify the polarization state into the mutually unbiased basis.

4 light sources may be coupled into the multiplexing module described above.

In further embodiments, 8 light sources are coupled via unbalanced PM fibre beam splitters into the multiplexing module outlined in claims 1-a-d, to produce 4 signal states (high intensity) and 4 decoy states (low intensity). This forms an optical encoder that produces 4 polarization states with 2 intensity levels without the need for active stabilization or manipulation in the generation of the states.

The polarization dependent phase picked up at the combining beam splitter may be corrected by a) series of birefringent waveplates b) a liquid crystal retarder

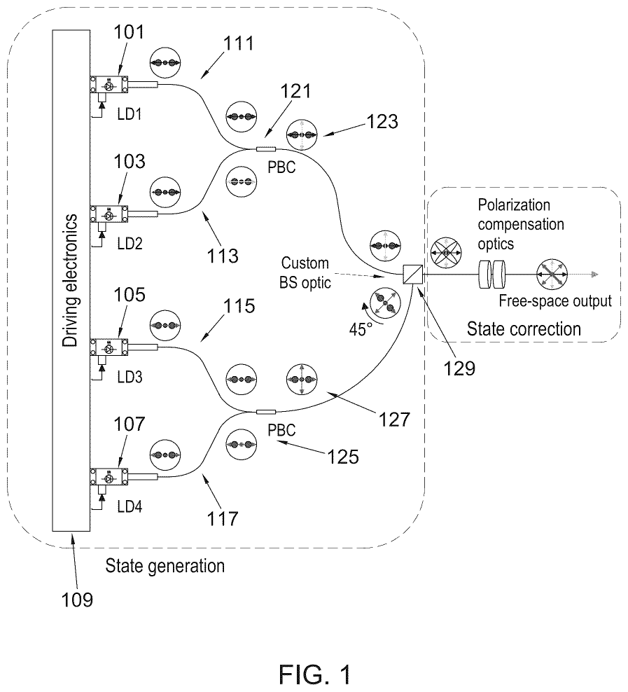

FIG. 1 shows a schematic of an encoding device or transmitter which is capable of encoding four polarisation states. The transmitter comprises a plurality of emitters, specifically a first emitter 101, a second emitter 103, a third emitter 105 and a fourth emitter 107. In an embodiment, the emitters are emitters of pulsed radiation. For example, the emitters may be polarised laser diodes, such as vertical cavity surface emitting lasers (VCSELs) or distributed feedback (DFB) lasers, or LEDs combined with linear polarization filters.

The plurality of emitters 101, 103, 105, 107 are connected to driving electronics 109 and each emitter is each individually addressable such that it can be selected via the driving electronics to output a pulse.

The transmitter will output a sequence of pulses where the polarisation of the pulses is selected between one of four polarisation states. In summary, in the system of FIG. 1, each emitter 101, 103, 105, 107 corresponds to a polarisation state such that activating a selected emitter to output a pulse will cause a pulse to be outputted from the encoder with the corresponding polarisation state.

In FIG. 1, each emitter 101, 103, 105, 107 outputs radiation with the same polarisation. The pulses are then passed through a hierarchy of combining stages. At each stage, two signals from the earlier stage are combined and the angle between the polarisation of the two signals which are combined is set to allow the formation of different polarisation states. The pulses are transferred from the emitters to the various combining stages and between the combining stages using polarisation maintaining fibres.

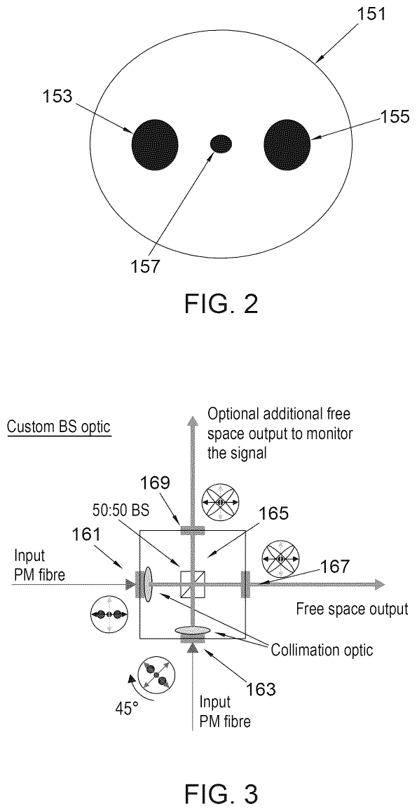

FIG. 2 is a schematic of a cross section of a polarisation maintaining fibre 151. The polarising maintaining fibre has a birefringence which allows two well defined polarisation modes which propagate along the fibre 151 with difference velocities. There are many different types of polarisation maintaining fibres. The fibre may be geometrically asymmetric or have a refractive index profile which is asymmetric.

Alternatively, stress may be permanently induced in the fibre to produce stress birefringence. This may be accomplished using rods of another material included within the cladding. FIG. 2 shows the so-called “PANDA” type where there are two rods 153 and 155 which produce stress birefringence around a central core 157. However, this is just an example and other types of fibre could be used.

Returning to FIG. 1, each of the emitters 101, 103, 105 and 107 are connected to driving electronics 109. Each emitter is also coupled to a polarisation maintaining fibre. In an embodiment, each emitter is coupled to the polarisation maintaining fibre such that the output of the emitter travels along the slow axis of the polarisation maintaining fibre.

The output of the first emitter 101 is coupled into polarisation maintaining fibre 111, the output of second emitter 103 is coupled into polarisation maintaining fibre 113. As noted above, the output from both emitters 101 and 103 coupled to the same axis of the fibre. Polarisation maintaining fibres 111 and 113 are then combined at first combining station 121.

The first combining station 121 comprises a 2×1 beam combiner which produces pulses at its output port. The first combining station will be referred to as a state combining station as it serves to couple together the states which will form a basis.

The slow axis of second polarisation maintaining fibre 113 is rotated with respect slow axis of first polarisation maintaining fibre 111 on entry into the first state combining station 121. This means that at the output of the first state combining station, pulses from polarisation maintaining fibre 111 are coupled to the slow axis of the output polarisation maintaining fibre. However, pulses from the second polarisation maintaining fibre 113 coupled into the fast axis of the output polarisation maintaining fibre. This is shown in the cross-section of the polarisation maintaining output fibre 123 on the figure which shows that both fast and slow modes are occupied.

Similarly, the output of the third emitter 105 is coupled into polarisation maintaining fibre 115, the output of fourth emitter 107 is coupled into polarisation maintaining fibre 117. As noted above, the output from both emitters 105 and 107 coupled to the same axis of the fibre. Polarisation maintaining fibres 115 and 117 are then combined at second state combining station 125.

The second state combining station 125 comprises a 2×1 beam combiner which produces pulses at its output port. The slow axis of fourth polarisation maintaining fibre 117 is rotated with respect slow axis of third polarisation maintaining fibre 115 on entry into the second combining state station 123. This means that at the output of the second state combining station, pulses from the third polarisation maintaining fibre 115 are coupled to the slow axis of the output polarisation maintaining fibre. However, pulses from the fourth polarisation maintaining fibre 117 coupled into the fast axis of the output polarisation maintaining fibre. This is shown in the cross-section of the polarisation maintaining output fibre 127 on the figure which shows that both fast and slow modes are occupied.

Therefore, the first state combining stage 121 has a polarisation maintaining fibre is its output which contains either horizontally polarised vertically polarised pulses dependent on whether the pulse is from emitter 101 or second emitter 103.

Also, the polarisation maintaining fibre which carries the output of the second state combining stage 125 outputs pulses which are either horizontally or vertically polarised dependent on whether they are output from the third emitter 105 for the fourth emitter 107.

The output from the first state combining stage 121 is output to what will be termed as the first main polarisation maintaining fibre and the output from the second state combining stage is output to what will be termed the second main polarisation maintaining fibre. These are then combined in the main combining stage 129.

The main combining stage is shown in more detail in FIG. 3. As, in this example, the main combining stage combines the basis formed in the state combining stage, it will be referred to as a basis combining stage. Here, the input from the first main polarisation maintaining fibre is provided at a first input port 161 and the input from the second main polarisation maintaining fibre is input at a second input port 163. The second input port is configured such that the slow axis of the second main polarisation maintaining fibre is rotated by 45° with respect to slow axis of the first polarisation maintaining fibre. It will be appreciated by those skilled in the art that although the above description has referred the slow axis, the same is true for the fast axis.

At the first input port 161 and the second input port 163, there are collimating optics which serve to further focus the incoming signals onto 50-50 beam splitter 165. The 50-50 beam splitter 165 serves as a combining optic to combine the signals from the first and second polarisation maintaining fibres. The output from the combining optic 165 is directed towards first output port 167 which is a free space output port or may also be a single mode fibre. In an embodiment, a collimator is provided in front of the single mode fibre. The output corresponds to pulses which have a polarisation selected from horizontal, vertical, diagonal or anti-diagonal polarisation. In this example the horizontally polarised pulses are from first emitter 101, the vertically polarised pulses from second emitter 103, the diagonally polarised pulses from third emitter 105 and the anti-diagonally polarised pulses from fourth emitter 107.

In addition to free space output 167, the half silvered mirror 165 allows an additional output 169 to be taken which can be used for monitoring the signal.

As explained above in relation to FIG. 2, the birefringence of polarisation maintaining fibre introduces a phase delay between horizontal and vertically polarised components travelling in the fibre (I.D slow and fast axis). Moreover, reflective surfaces will give additional path length for one of the polarization states. When measured on the rectilinear basis, this phase difference is not picked up since it will act as a global phase. However, for a rotated and mutually unbiased basis (D and A), the phase will introduce ellipticity and will result in lower visibility upon polarization measurement. As, in embodiments, the encoder is intended for use with QKD protocols, this relative phase needs to be compensated to minimize the quantum bit error rate.

In an embodiment, a correction on the polarization state is implemented by fibre based or free space polarization controllers. This can be static or electronically controlled. Typically, this is implemented in free space by the use of a liquid crystal retarder or a series of wave plates (quarter-wave plate, half-wave plate, quarter-wave plate). This allows for the phase difference between the H and V components of the A and D polarization states to be compensated without rotating the polarization state of the pure H and V states.

The same transformation can be achieved using a 3- or 4-axis (electronic) polarization controller in single mode fibre.

For the free space output, the phase does not vary with time. However, a single-mode fibre can introduce both relative phase and the rotation of the axis which can be compensated using an electronically controllable polarization rotator. In an embodiment, there is a set of polarization rotators and retarders. This may be done using design with λ/4—λ/2—λ/4 (quarter wave plate—half wave plate—quarter wave plate). Alternatively, the same effect could be achieved using a set of birefringent liquid crystals

It is not strictly necessary to compensate the polarisation at the transmitter location. A single mode fibre would add a rotation and/or relative phase to the polarisation states, but they would still be in a mutually unbiased basis set (albeit not H, V, A, D and instead with some ellipticity of arbitrary angle). This can be compensated for at the receiver using the polarization rotator/retarder. The issue would be how quickly this can be achieved and it would probably be useful to have a bright polarisation reference in addition to the quantum signal. Alternatively if the polarisation states are fixed at the transmitter site then only a rotation of the polarisation should be required to compensate for the polarisation rotation due to the orientation of the transmitter with respect to then receiver.

In an embodiment, the phase compensation can be realized by measurements at the receiver module and information on how to apply the proper transformation at the transmitter can be transferred along with the classical data traffic required for QKD.

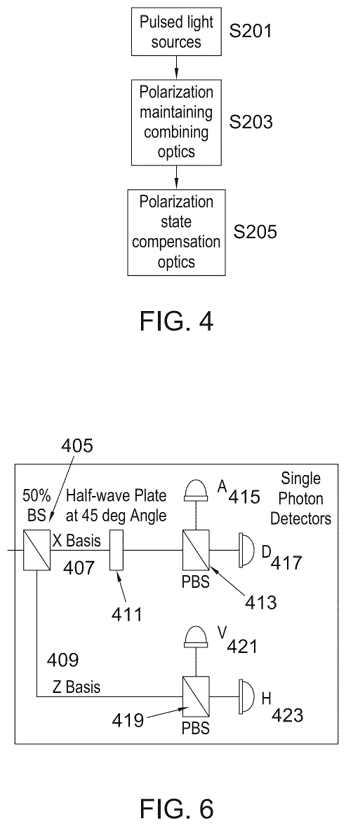

FIG. 4 shows a summary of the above system. In step S201, emitters which are pulsed light sources are used to emit pulsed radiation. Typically, the pulses will have a fixed polarisation. These are then fed into polarisation maintaining combining optics in step S203. In an embodiment, the polarisation maintaining combining optics comprise polarisation maintaining fibres. The polarisation maintaining fibres are used to rotate the polarisation of the pulses emitted from the different emitters with respect to one another such that pulses from one emitter are combined with pulses from another emitter with a fixed rotation between the polarisations of the pulses from the two emitters. The polarisation maintaining combining optics may be arranged in a hierarchical manner so that pairs of outputs from emitters are combined in a hierarchical manner to allow the output of four or more emitters to be combined into a single output.

Due to the phase delay induced by interaction with the beam splitter of the main combining unit, polarisation state compensation optics are used to compensate for this phase delay.

The above encoder can be used for quantum key distribution (QKD). A basic quantum communication protocol which uses polarisation will now be explained.

However, it should be noted that this is not meant as limiting and other polarisation based protocols could also be used.

The protocol uses two bases wherein each basis is described by two orthogonal states. For this example the basis of H/V and D/A. However, the L/R basis could also be selected.

The sender in the protocol prepares states with one of H, V, D or A polarisation. In other words, the prepared states are selected from two orthogonal states (H and V or D and A) in one of two bases H/V and D/A. This can be thought of as sending a signal of 0 and 1 in one of two bases, for example H=0, V=1 in the H/V basis and D=0, A=1 in the D/A basis. The pulses are attenuated so that they comprise on average, one photon or less. Thus, if a measurement is made on the pulse, the pulse is destroyed. Also, if the pulse contains one photon, then it is not possible to split the pulse.

The receiver uses a measurement basis for the polarisation of a pulse selected from the H/V basis or the D/A basis. The selection of the measurement basis can be active or passive. In passive selection the basis is selected using fixed components, such as a beam splitter. In “active” basis choice, the receiver makes a decision which basis to measure in—e.g. using a modulator with an electrical control signal. If the basis used to measure the pulse at the receiver is the same as the basis used to encode the pulse, then the receiver's measurement of the pulse is accurate. However, if the receiver selects the other basis to measure the pulse, then there will be a 50% error in the result measured by the receiver.

To establish a key, the sender and receiver compare the basis that were used to encoder and measure (decode). If they match, the results are kept, if they do not match the results are discarded. The above method is very secure. If an eavesdropped intercepts the pulses and measures then, the eavesdropper must prepare another pulse to send to the receiver. However, the eavesdropper will not know the correct measurement basis and will therefore only has a 50% chance of correct measuring a pulse. Any pulse recreated by the eavesdropper will cause a larger error rate to the receiver which can be used to evidence the presence of an eavesdropper. The sender and receiver compare a small part of the key to determine the error rate and hence the presence of an eavesdropper.

The encoder described with reference to FIG. 1 can be used to prepare the four states required for the above described BB84 protocol.

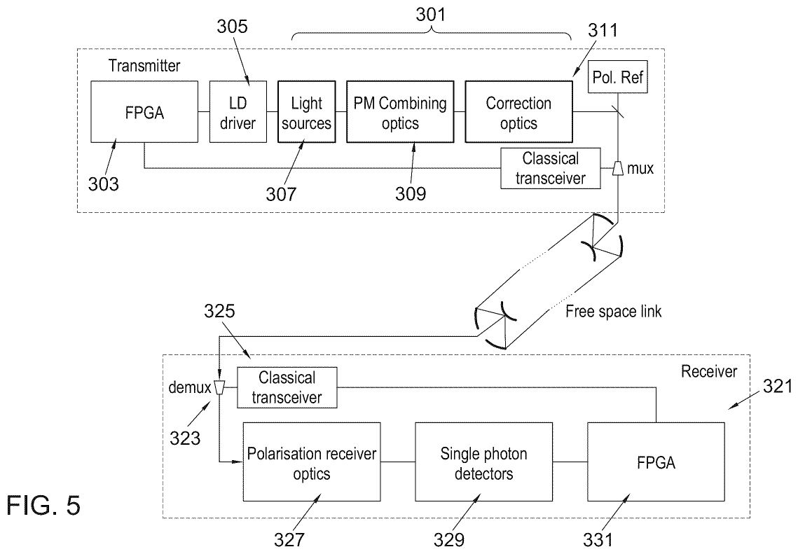

FIG. 5 is a diagram showing a QKD system in accordance with an embodiment using the transmitter of FIG. 1. The above described transmitter is suitable for use in any QKD system, including point-to-point links and more recent protocol developments such as MDI QKD.

FIG. 5 shows the transmitter of FIG. 1 deployed in a point-to-point QKD system. Here, the 4. Here the transmitter 301 is driven by an FPGA 303 which is connected to a driver 305 which provides the high-speed signal used to selectively excite the emitters. The driver is a suitable laser driver which is implemented such that the emitters are gain-switched and therefore produce optical pulses with a random phase at each clock cycle. In an embodiment, the laser driver takes the digital signal from the FPGA and produces an analog output capable of driving the laser diodes or LEDs in gain-switched operation, turning the light source off completely between each pulse. Driving the light source in this way means that each pulse will have a random phase due to being seeded from a vacuum photon (spontaneous emission).

The emitters 307 are multiplexed via the PM combining optics 309 as described above in relation to FIG. 1. The output is corrected by correction optics 311 to transmit the desired states for the QKD protocol implemented. In this embodiment, the encoded light pulses can be sent over a free space link.

In an embodiment, the system can be used for the BB84 protocol, where the FPGA is used to randomly select an emitter to output a pulse. Due to the arrangement of the polarising maintaining fibres and combining stages, the selection of a polarisation state is performed by selecting an emitter.

In this embodiment, the prepared state is then sent via free space or a single mode fibre to receiver 321. The receiver may be any type of receiver used to measure polarisation states in QKD.

Receiver 321 receives the multiplexed signal and de-multiplexes the signal at demultiplexer 323. The demultiplexer directs the classical signal (clock signal) into classical transceiver 325 which is then directed towards receiver FPGA 331. The encoded pulses are directed first into polarisation receiver optics 327 and into single photon detectors 329.

The combination of the polarisation receiver optics 327 and the single photon detectors 329 can be the same as that used in any standard QKD system for polarisation encoding. An example of a possible arrangement is shown in FIG. 6.

Here, the polarisation receiver optics comprises a 50-50 beam splitter 405 which will direct the incoming pulse either along first measurement channel 407 or a second measurement channel 409. Since the pulses contain on average less than one photon, the 50-50 beam splitter 405 will direct the pulse randomly along one of the first measurement channel or the second measurement channel. This has the result of selecting a measurement basis to be the X (D/A) basis or the Z (H/V) basis.

The non-polarising beam splitter 405 functions to allow random selection of one of the two bases.

The first measurement channel is for the X basis which corresponds to the D/A bases. Here, a half wave plate 411 is provided to rotate the polarisation by 45 degrees between the two detection branches, i.e. giving the 2 measurement bases X and Z. The output of the half wave plate 411 is then directed towards polarising beam splitter 413. Polarising beam splitter 413 directs pulses with anti-diagonal polarisation towards anti-diagonal detector 215 and pulses with a diagonal polarisation towards diagonal detector 417. Detectors 415 and 417 are single photon detectors, for example avalanche photodiodes.

Pulses directed along the second measurement channel are measured in the Z basis to determine if they are horizontal or vertical. Here, the pulses directed into the second measurement channel are directed toward polarising beam splitter 419 which directs vertically polarised pulses towards detector 421 and horizontally polarised pulses towards detector 423. Again, detectors 421 and 423 are single photon detectors.

If a photon is received which is polarised in the D/A bases and this is randomly sent to be measured in the Z bases along the second management channel 409, one of detectors 421, 423 are likely to register a count. However, this result cannot be trusted as a photon received at polarising beam splitter 419 has a 50-50 chance of being directed towards either the vertical or the horizontal detector. Therefore, this result is discarded.

The above discussion of QKD has assumed that each pulse sent to the receiver has a fixed intensity. However, so-called decoy state QKD protocols are also used where the pulses are sent with different intensities such that there is a plurality of intensities for each state. One possible attack on a QKD system is the so-called photon number splitting (PNS) attack. In this attack, pulses are intercepted between the transmitter and receiver. The pulses on average contain less than one photon.

However, as the number of photons in each pulse will vary, some pulses may contain two photons. This allows the PNS attack to take place where an eavesdropper splits each pulse and if there is more than one photon, the photon not read by the eavesdropper carries onto the receiver. In this situation, the presence of the eavesdropper can be determined by using pulses with differing intensity levels (a so-called decoy state protocol). The PNS attack causes a variation in the bit error rate at the different intensities.

The risk of pulse splitting attacks in QKD are mitigated first by using low flux i.e. on average less than one photon per pulse but also by use of states, which have a different flux, say 10 times lower (decoy) and >1000 times lower (vacuum). It can then be proven that the communication is secure against this type of attack for BB84 protocol.

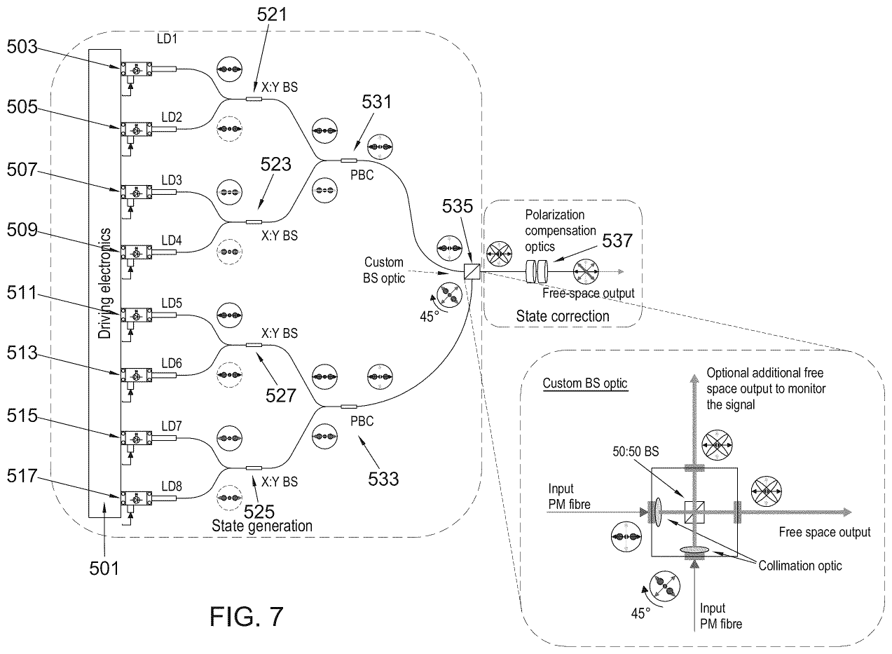

FIG. 7 shows a variation on the transmitter of FIG. 1 which has been adapted for emitting pulses of differing intensities. The transmitter of FIG. 7 has 8 emitters. Each pair of emitters corresponds to a polarisation state and in this example, there are two intensity levels. This is achieved by the provision of an unbalanced combination stage with an unbalanced combiner which serves to attenuate the output from one of the emitters of the pair of emitters that it combines. Thus, the output from the unbalanced combining stage is a sequence of pulses of the same polarisation having intensities randomly varying between two different levels. The output from this stage is then passed to the first combining stage which allows the states which define one basis to output in the same polarisation maintaining fibre.

In more detail, the transmitter of FIG. 7 is used to generate 4 polarization states with 2 intensity levels via multiplexing of 8 pulsed light sources using PM fibre optical components.

The transmitter of FIG. 7 shows the generation of the polarization states H, V, D and A. The sources/emitters 503, 505, 507, 509, 511, 513, 515 and 517 are coupled to driving electronics 501 and are selectively excited depending on the desired output state. Each light source/emitter corresponds to a specific polarization state and intensity level at the output of the transmitter module. In this example, the output of each source/emitter is coupled to the slow axis of a PM fibre (nominally the H polarization state).

Pairs of emitters 503, 505, 507, 509, 511, 513, 515 and 517 are then coupled to 4 unbalanced PM fibre 2×1 beam combiners 521, 523, 525, 527 producing pulses of light at the output port with an intensity ratio set by the combining ratio (X:Y).PM fibre. The 4 unbalanced 2×1 beam combiners form the unbalanced combination stage which will be referred to as the intensity combining combination stage. This allows the production of decoy states in BB84 protocol QKD, where the intensity ratio is chosen to optimize the key rate based on the specific system parameters (channel loss, repetition rate, quantum bit error rate, etc.).

The output of the 4 unbalanced beam combiners 521, 523, 525, 527 are coupled to two polarization beam combiners (PBC) 531, 533 which form the state combination stage where, in this example, the states which form each basis are combined into a single polarisation maintaining fibre. Here, the polarization state of one of the inputs is rotated by 90 degrees and the light pulses propagate along the fast axis of the output PM fibre. The other input is left unaffected and persists to propagate along the slow axis of the output fibre. The outputs of the two PBCs 531, 533 therefore, contain orthogonally propagating light pulses (nominally H and V polarization states).

Finally, the outputs of the PBCs are input to a custom 50:50 beam splitter optic 535 which is the same as the main combining unit of FIGS. 1 and 3 and forms the basis combination stage. Here one of the PM fibre inputs is mechanically rotated by 45 degrees to convert the orthogonally polarized states into the mutually unbiased basis i.e. H, V→A, D. The light is coupled out of the fibre inside the custom optic via collimation lenses and then impinged upon a 50:50 beam splitter cube. This acts to combine the 4 polarization states which are coupled out to either a single mode fibre (via a further collimation optic) or to free space.

The output from the main combining stage is then passed through correction optics 537. These are the same as the correction optics described with reference to FIG. 1.

In the above description, two embodiments have been described, the first is used to prepare 4 states of the same intensity, and the second is used to prepare 4 states with two intensity levels. However, it will be understood that the system could be used to prepare fewer than or greater than the number of states described above. Also, more than two intensity levels could be implemented. In a further embodiment, vacuum states can also be sent, for these, no laser pulse is emitted.

For example, the system could be implemented to use a simplified B92 protocol where there are just two states one in the H/V basis and the other in the D/A basis. In this arrangement, two emitters would each output pulses via a polarisation maintaining fibre to the main combination stage 129 of FIG. 1.

Also, more intensity levels could be introduced by using, for example, 4 emitters to produce each state with 4 different intensity levels. The 4 emitters being combined in pairs in a first unbalanced combining stage such that there are two polarisation maintaining fibres output from the first unbalanced combining each fibre containing pulses of different intensities and a second unbalanced combining stage where the outputs from the first unbalanced combining stage are combined. The second unbalanced combining stage may also comprise an unbalanced combiner. However, if the unbalanced combiners in the first unbalanced combining stage are different to each other, the second unbalanced combining stage may have a balanced combiner.

Similarly, fewer or more polarisation states may be prepared. The above examples have used two states per basis, but it is possible to have two states in one basis and just one state in the other basis. Here, the basis with just one state would not need to pass through the first combining stage and may be directed to the main combining stage.

The above has been described primarily in relation to the polarisation states being output by pulsed optics. However CW sources with an intensity modulator could also be used.

Also, the combined basis above are H/V with D/A. However, it is possible for one of the basis to be switched to be circularly polarised. This would be achieved by use of a quarter waveplate prior to the free space combination.

In the above embodiments, the setup uses polarization-maintaining fibre to multiplex different polarization states exploiting the mechanical rotation of the fibre to achieve polarization rotation. This ensures that there is no need for on-the-fly manipulation of the polarization states.

This also reduces the need for monitoring devices at each stage of polarization state as no polarization alignment is required. This reduces the size, cost and weight of the system. Correction of the output state due to imperfections in the setup can be easily accounted for using common optical polarization components and once set do not need to be acted upon again.

The system does not require any active alignment procedure so is an ideal candidate for use in hostile or inaccessible environments. A polarization beacon/reference can be easily coupled and will maintain its relative orientation to the encoded channel.

The system is low weight-predominantly fibre-coupled optical components reduce weight due to no requirement for stabilized optomechanical components. Also, the system has low power consumption-low power laser drivers can be used in conjunction with efficient light sources. No optical modulators requiring high driving voltages are needed

It also has a small form factor as optical fibres can be wound into small area. No large polarization optics are needed in the state generation. Fibre coupling allows additional lasers for other intensity levels to be coupled into the module easily.

Fully fibre-connected optical design makes the system more robust to vibration or other mechanical stress that could misalign a free-space coupled alternative

Lack of need for dynamic control of the polarization states means that the optical assembly can be small and cost effective.

The optical module can be used as the transmitter side for free-space quantum key distribution.

The generation of optical pulses with encoded information at high clock rates is a key building block for optical communications. The state of polarisation of light is one of the most common optical properties which can be modulated to encode information (e.g., polarisation shift keying). For practical communication system applications, optical transmitters should be simple, compact, low cost, and have low power consumption. The above embodiments provide these benefits and thus could be used in numerous communication areas.

As explained above, the transmitter can be used in quantum communication systems. The transmitter design is ideally suited for polarisation-encoding quantum key distribution (QKD) and polarisation-encoding measurement device independent quantum key distribution (MDI QKD) devices. Polarisation encoding is particularly important for free-space QKD applications, such as Satellite QKD.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A combining unit for combining a first optical input and a second optical input, the first optical input comprising a first polarisation maintaining fibre “PMF” having a fast optical axis and a slow optical axis, the second optical input comprising a second PMF having a fast optical axis and a slow optical axis,
the combining unit being configured to combine the first optical input with the second optical input in free space such that the fast and slow optical axis of the first PMF and the second PMF are rotated with respect to one another by a non-zero angle to produce a combined signal.

2. The combining unit of claim 1, further comprising an output configured to output the combined signal to free space.

3. The combining unit of claim 1, further comprising a correction stage configured to correct for the phase offset between the outputs of the first and second PMFs.

4. A transmitter for emitting light with a polarisation selected from a set of fixed polarisations, the emitter comprising:
a main combining stage comprising the combining unit of claim 1; and
a plurality of emitting units, the output of each emitting unit being directed into a PMF such that the output of at least one emitting unit is directed to the first PMF and the output of at least one other emitting unit is directed to the second PMF.

5. The transmitter of claim 4, further comprising a plurality of hierarchical combining stages, each being configured to combine two inputs into a single output, the single output being directed to the following combining stage via a PMF.

6. The transmitter of claim 4, configured to selectively output from the main combining stage at least one polarisation state in one of two non-orthogonal basis.

7. The transmitter of claim 6, further comprising at least one further combining stage as a state combining stage, the state combining stage being configured to combine orthogonal polarisation states which form a basis into a single output, the main combining stage being configured as a basis combining stage to combine the outputs of the state combining stage.

8. The transmitter of claim 7, wherein the state combining stage is configured to combine polarisation states propagating in the same axis of two input PMFs and wherein the state propagating in one input PMF is coupled into the slow axis of a PMF carrying the output of the state combining stage and the state propagating in the other input PMF is coupled to the fast axis of the PMF carrying the output of the state combining stage.

9. The transmitter of claim 7, wherein the state combining stage comprises a 2×1 fibre combiner.

10. The transmitter of claim 7, comprising two state combining stages one configured to output to the first PMF and the other configured to output to the second PMF, the axis of the second PMF being rotated by 45 degrees with respect to the axis of the first PMF by the basis combining stage.

11. The transmitter of claim 6, further comprising at least one further combining stage as an intensity combing stage, the intensity combining stage being configured to combine polarisation states with the same polarisation but different intensities into a single output.

12. The transmitter of claim 11, wherein the intensity combining stage is configured to combine polarisation states propagating in the same axis of N input PMFs, where N is a integer of at least 2 and wherein the states propagating in each input PMF are each coupled into the same axis of a PMF carrying the output of the intensity combining stage.

13. The transmitter of claim 12, wherein the intensity combining stage comprises a Nx1 fibre combiner.

14. The transmitter of claim 4, further comprising driving electronics connected to each of the plurality of emitters to allow each of the plurality of emitters to be selectively excited such that a polarisation state output from the main combining stage can be selected by exciting the corresponding emitter.

15. The transmitter of claim 14, further configured to output vacuum states at selected time by not selecting any emitter to output at the selected time.

16. A quantum communication system comprising the transmitter of claim 4, and a receiver, said receiver being configured to receive polarisation states from said transmitter and measure said polarisation states in a first or a second polarisation basis.

17. The quantum communication system of claim 16, wherein the receiver is configured to passively select the polarisation basis.

18. A method for combining a first optical input and a second optical input, the first optical input being provided via a first polarisation maintaining fibre “PMF” having a fast optical axis and a slow optical axis, the second optical input being provided via a second PMF having a fast optical axis and a slow optical axis,
wherein the first optical input is combined with the second optical input in free space such that the fast and slow optical axis of the first PMF and the second PMF are rotated with respect to one another by a non-zero angle to produce a combined signal.

19. A method of transmitting an optical signal with a polarisation selected from a set of fixed polarisations, the method comprising:
emitting polarisation states from a plurality of emitting units, the output of each emitting unit being directed into a PMF such that the output of at least one emitting unit is directed to a first PMF and the output of at least one other emitting unit is directed to the a second PMF;
combing the output of the first PMF with the output of the second PMF in free space to produce a combined signal, wherein the optical axis of the second PMF is rotated with respect to the optical axis of the first PMF.

20. A quantum communication method, the method comprising:
emitting an optical signal with polarisation states selected from a set of sixed polarisations according to the method of claim 19, wherein the polarisation states are randomly selected from states in two polarisation basis; and
receiving at a receiver the optical signal with varying polarisation states and varying the polarisation measurement basis in the receiver.
